(19) United States
(12) Patent Application Publication
(10) Pub. No.: US 2014/0297999 A1
(43) Pub. Date: Oct. 2, 2014

(54) COMPUTER SYSTEM AND METHOD FOR CONTROLLING ACPI INFORMATION

(71) Applicant: SAMSUNG ELECTRONICS CO., LTD., Suwon-si (KR)

(72) Inventors: Kyung-Hwan Kim, Seoul (KR); Youn-Hee Kim, Seoul (KR); Young-Gun Jang, Gunpo-si (KR)

(73) Assignee: SAMSUNG ELECTRONICS CO., LTD., Suwon-si (KR)

(21) Appl. No.: 14/187,553

(22) Filed: Feb. 24, 2014

(30) Foreign Application Priority Data
Mar. 27, 2013 (KR) 10-2013-0032901

(51) Int. Cl. G06F 9/445

(52) U.S. Cl. CPC G06F 9/44505
USPC 713/1

(57) ABSTRACT

A computer system configured to control advanced configuration and power interface ACPI information is provided. The computer system includes a non-volatile memory configured to store an ACPI table, and a processor configured to execute a unified extensible firmware interface (UEFI), wherein a boot service of the UEFI provides a shell application, and the shell application includes an extended command to control information of the ACPI table.

### CROSS-REFERENCE TO RELATED APPLICATION

This application claims to Korean Patent Application No. 10-2013-0032901 filed on Mar. 27, 2013 in the Korean Intellectual Property Office, and all the benefits accruing therefrom under 35 U.S.C. 119, the disclosure of which is incorporated by reference in its entirety herein.

### BACKGROUND

1. Technical Field

Exemplary embodiments of the present inventive concept relate to a computer system for controlling advanced configuration and power interface (ACPI) information and a method for controlling the ACPI information.

2. Discussion of Related Art

A basic input/output system (BIOS) is currently used as boot firmware of a computer system. However, since the BIOS cannot support 64 bit personal computers or ARM based devices, an extensible firmware interface (EFI) has been developed to overcome the shortcomings of the BIOS. The EFI is implemented as an open source to become a unified extensible firmware interface (UEFI) and may be used to replace the BIOS.

### SUMMARY

At least one embodiment of the present inventive concept provides a computer system for controlling ACPI information using a shell application provided from a unified extensible firmware interface (UEFI).

At least one embodiment of the present inventive concept also provides a method for controlling ACPI information using a shell application provided from a unified extensible firmware interface (UEFI).

According to an exemplary embodiment of the present inventive concept, there is provided a computer system for controlling ACPI information. The computer system includes a non-volatile memory storing an ACPI table, and a processor executing a unified extensible firmware interface (UEFI), wherein a boot service of the UEFI provides a shell application, and the shell application includes an extended command for controlling information of the ACPI table.

According to an exemplary embodiment of the present inventive concept, there is provided a method for controlling the ACPI information, the method comprising loading a shell application provided from UEFI boot services, receiving an extended command for controlling information of an ACPI table using the shell application, changing the ACPI table according to the received extended command, and storing the changed ACPI table in a non-volatile memory.

According to an exemplary embodiment of the present inventive concept, there is provided a computer system for controlling ACPI information. The computer system includes a main memory storing an ACPI table and a processor configured to execute a UEFI. A boot service of the UEFI provides a shell application, and the shell application includes an extended command configured to change the ACPI table.

### BRIEF DESCRIPTION OF THE DRAWINGS

The inventive concept will become more apparent by describing in detail exemplary embodiments thereof with reference to the attached drawings in which:

FIG. 1 is a block diagram illustrating a computer system using a unified extensible firmware interface (UEFI);

FIG. 2 illustrates an architecture of an ACPI table shown in FIG. 1;

FIG. 3 illustrates an ACPI namespace of a differentiated definition block shown in FIG. 2;

FIG. 4 is a flowchart illustrating a method for controlling ACPI information using a shell application according to an exemplary embodiment of the present inventive concept;

FIG. 5 is a block diagram of an exemplary computer system to which the method for controlling ACPI information shown in FIG. 4 may be applied;

FIG. 6 illustrates an exemplary table for explaining extended commands according to an exemplary embodiment of the inventive concept;

FIG. 7 illustrates that an extended command is input to a terminal window according to an exemplary embodiment of the inventive concept;

FIG. 8 is a block diagram for explaining an application example of a computer system to which the method for controlling ACPI information shown in FIG. 4 may be applied;

FIG. 9 is a block diagram for explaining an application example of a computer system to which the method for controlling ACPI information shown in FIG. 4 may be applied; and

FIG. 10 is a block diagram for explaining an application example of a computer system to which the method for controlling ACPI information shown in FIG. 4 may be applied.

### DETAILED DESCRIPTION

The present inventive concept will now be described more fully hereinafter with reference to the accompanying drawings, in which exemplary embodiments thereof are shown. The invention may, however, be embodied in different forms and should not be construed as limited to the embodiments set forth herein. The same reference numbers indicate the same components throughout the specification. In the attached figures, the thickness of layers and regions may be exaggerated for clarity.

It will also be understood that when a layer is referred to as being “on” another layer or substrate, it can be directly on the other layer or substrate, or intervening layers may also be present. The use of the terms “a” and “an” and “the” and similar references in the context of describing the invention are to be construed to cover both the singular and the plural, unless otherwise indicated herein or clearly contradicted by context.

Hereinafter, embodiments of the present invention will be described with reference to the accompanying drawings.

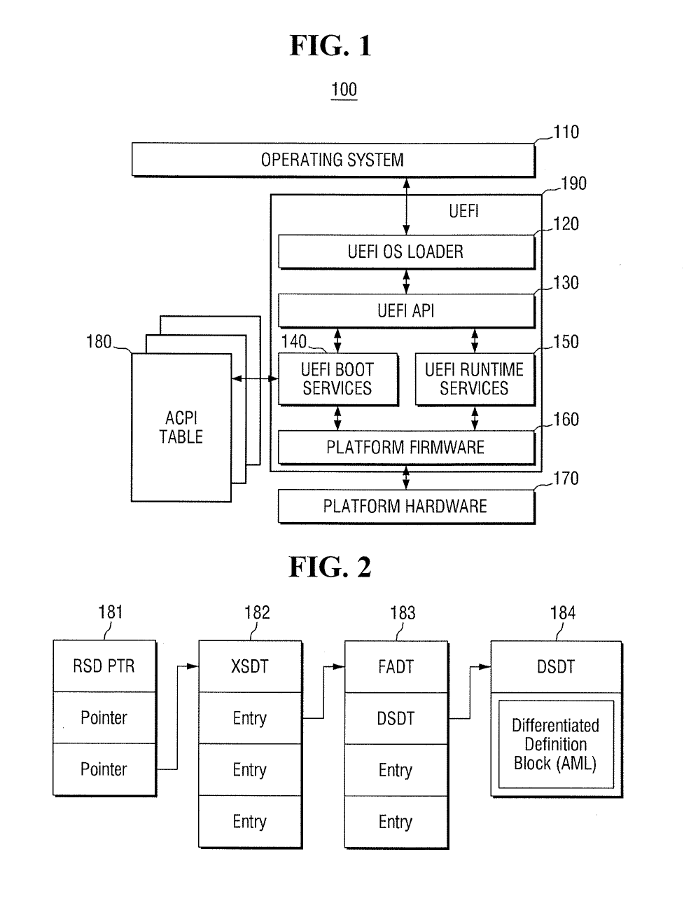

FIG. 1 is a block diagram illustrating a computer system using a unified extensible firmware interface (UEFI).

Referring to FIG. 1, the computer system 100 using UEFI includes platform hardware 170, a UEFI 190, and an operating system (OS) 110.

The platform hardware 170 may include hardware components of the system 100. In an exemplary embodiment, the platform hardware 170 includes a processor, a storage device, an input device, and so on.

The processor may include an Intel® 64 processor, an IA-32 processor, an Intel® Itanium® based processor, an x64 processor, an ARM processor, and so on, but exemplary embodiments of the present inventive concept are not limited thereto. The processor may execute UEFI, which will later be described. The storage device may include a main memory (e.g., a random access memory RAM), secondary memory, and other types of memories. The secondary memory may include a non-volatile memory. The other types of memories may be provided as various types of storage media, including a floppy disk, a hard disk, CD-ROM, DVD, and so on. The input device may include a key board, a mouse, a key pad, a touch panel, and so on, but exemplary embodiments of the present inventive concept are not limited thereto.

The UEFI 190 may provide a standard environment for booting the operating system 110. To this end, the UEFI 190 may include a UEFI application program interface (UEFI API) 130, UEFI boot services 140, UEFI runtime services 150, and a platform firmware 160.

The UEFI API 130 may be configured to interface between the platform firmware 160 and the operating system 110.

The UEFI boot services 140 may provide interfacing between devices and system functions during a boot time of the operating system 110. The UEFI runtime services 150 may provide resources of the platform hardware 170 to the operating system 110 during a normal operation of the operating system 110.

The platform firmware 160 may initialize the processor, the storage device, etc. of the platform hardware 170. The platform firmware 160 may load a UEFI boot manager, which will later be described.

The UEFI boot manager may load a UEFI driver and a UEFI application. The UEFI boot manager may load the UEFI OS loader 120. Here, the UEFI boot manager may provide a boot option menu, and a user may select the UEFI OS loader 120 or the shell application through the boot option menu. The boot option menu may include legacy boot options. The boot manager may load the UEFI OS loader 120 or the shell application according to the boot option selected by the user. The term “loaded” used herein may mean being loaded to a main memory (not shown).

In an exemplary embodiment, the shell application refers to the UEFI shell, which can be used to execute other UEFI applications, including UEFI boot loaders. Apart from that, commands in the UEFI shell can be used for obtaining various other information about the system or the firmware, such as retrieving the memory map, modifying boot manager variables, running partitioning programs, loading UEFI drivers, editing text files, etc.

The UEFI OS loader 120 may boot the operating system 110. To this end, the UEFI OS loader 120 may use the UEFI boot services 140 and the UEFI runtime services 150.

The detailed contents of the UEFI specifications are disclosed in more detail in “Unified Extensible Firmware Interface Specification Version 2.3.1 [Apr. 6, 2011],” the disclosure of which is incorporated by reference in its entirety herein.

The operating system 110 may include Linux®, Windows®, and so on, but exemplary embodiments of the present inventive concept are not limited thereto.

Hardware configuration information and power management information are stored in the ACPI table 180. The ACPI table 180 may be stored in a non-volatile memory (not shown) in a file format. The ACPI table 180 may be loaded to a main memory from the non-volatile memory to then be used.

FIG. 2 illustrates architecture of an advanced configuration and power interface (ACPI) table shown in FIG. 1.

Referring to FIG. 2, the architecture of the ACPI table 180 will now be described. First, a root system description pointer (RSDP) structure 181 may be set by the platform firmware 160. A pointer pointing to the RSDP structure 181 may be provided by the UEFI OS loader 120. The RSDP structure 181 may include an address of an extended system description table (XSDT) 182. The XSDT may provide the same functionality as a root system description table (RSDT), but accommodates physical addresses of description headers that are larger than 32 bits.

The XSDT 182 may point to another description table in the memory. The XSDT 182 may point to a fixed ACPI description table (FADT) 183.

The FADT 183 may point to a differentiated system description table (DSDT) 184.

The DSDT 184 may include a differentiated definition block (DDB). The differentiated definition block may include objects arranged in a hierarchical tree structure, that is, an ACPI namespace. The objects may include a data object, a control method object, a bus/device package object, a processor package object, a power resources package object, and so on. The objects are coded in an ACPI machine language (AML) and may be interpret by an AML interpreter. The data object may have a static or dynamic value.

Although not shown in FIG. 2, the FADT 183 may also point to a secondary system description table (SSDT), and a system resource affinity table (SRAT). The DSDT 184, SSDT, and SRAT may provide description of system hardware in a platform-independent manner, and may be presented as either fixed-formatted structures or in AML.

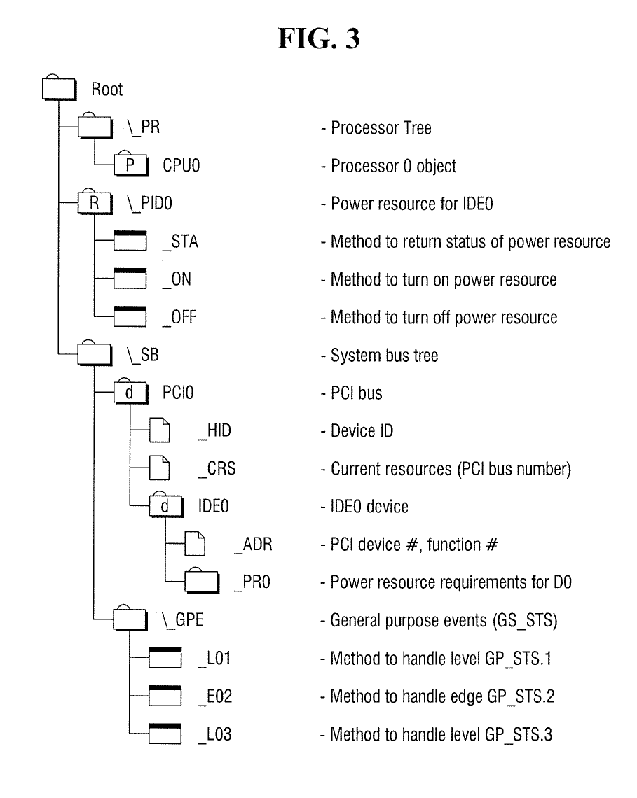

FIG. 3 illustrates an ACPI namespace of a differentiated definition block shown in FIG. 2.

Referring to FIG. 3, the ACPI namespace may have a hierarchical tree structure. The ACPI namespace may include design information and power information of platform hardware. The ACPI namespace may be used to refer to an object.

An ACPI namespace path may have a plurality of types. The ACPI namespace may have absolute namespace paths and relative namespace paths. The absolute namespace paths may start with ‘\’ and the relative namespace paths may start with ‘̂’. The absolute namespace path may be used to refer to a root of a namespace, and the relative namespace path may be used to refer to a parent of a current namespace. The name of the differentiated definition block may start with ‘_’.

The detailed contents of the ACPI specifications are disclosed in “Advanced Configuration and Power Interface Specification Revision 5.0 [Dec. 6, 2011]” the disclosure of which is incorporated by reference in its entirety into this specification.

The operating system 110 may perform power management using the ACPI namespace. The operating system 110 may load or unload the differentiated definition block using the UEFI runtime service 150 to change the contents of the ACPI namespace.

The RSDP structure 181 and the description tables may be loaded to the main memory.

In a computer system using the conventional UEFI, the ACPI table is coded in AML. Thus, in order to change the ACPI table, according to an exemplary embodiment of the inventive concept, an ASL (ACPI Source Language) file is compiled and then stored in a storage device. Alternatively, the ACPI table is restricted to return or set up using the application program interface provided by the operating system.

In the method for controlling ACPI information using the shell application according to an exemplary embodiment of the present inventive concept, which will be described below, the ASL file is compiled and then stored in a storage device. Alternatively, the ACPI table information may be controlled without using the application program interface provided by the operating system.

In an exemplary embodiment of the present inventive concept, the information about the ACPI table 180 is controlled using a user-friendly shell application, thereby increasing a user's convenience. In addition, the use of the ACPI table protocol may facilitate the controlling of the information about or within the ACPI table 180. The changed ACPI table 180 is stored in the non-volatile memory so as to be applied when the system is rebooted. The above-described method can be applied to computer platforms of various operation systems using UEFI without restriction.

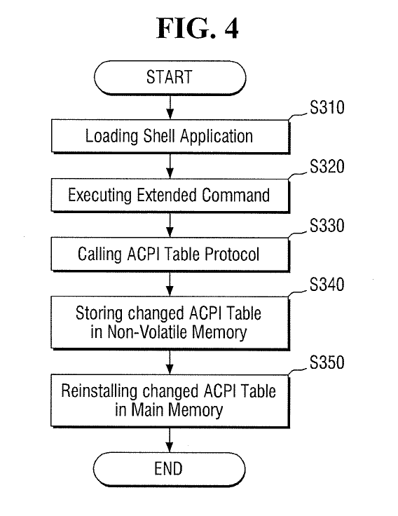

FIG. 4 is a flowchart illustrating a method for controlling ACPI information using a shell application according to an exemplary embodiment of the present inventive concept.

Referring to FIG. 4, first, the UEFI 190 is booted to load a shell application (S310). The shell application may be provided by the UEFI boot service.

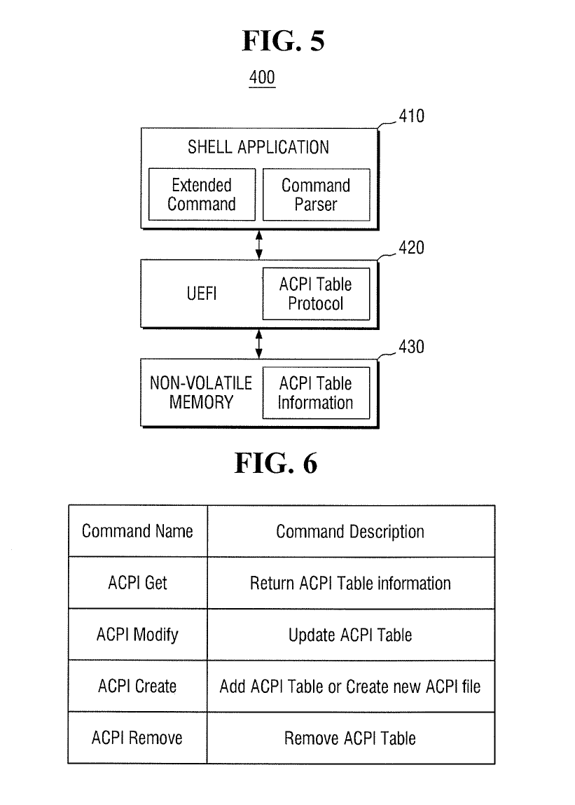

Next, the shell application receives an extended command for controlling information about or within the ACPI table 180 (S320). The extended command may include an ACPI Modify command, an ACPI Create command, and an ACPI Remove command. The extended command may also include an ACPI Get command. The extended command will later be described in detail with reference to FIG. 5. In an exemplary embodiment, the extended command is a new command not previously supported by the shell environment of a conventional UEFI shell.

The user may input the extended command to a terminal window on which the shell application is executed. Here, the shell application may load data of the ACPI table 180 stored in the non-volatile memory in a file format to the main memory.

Next, the shell application calls an ACPI table protocol (S330). To this end, the shell application may include a command parser for processing the extended command when the extended command is input. Here, the data of the ACPI table 180 loaded to the main memory may be changed using a factor (e.g., an input parameter) input together with the extended command.

Next, the changed ACPI table 180 is stored in the non-volatile memory (S340). The data of the changed ACPI table 180 may be stored in the non-volatile memory in a file format. When power supply is unexpectedly interrupted, the data of the changed ACPI table 180 may be lost. Thus, the data of the changed ACPI table 180 is first stored in the non-volatile memory for the time being. In addition, the ACPI table 180 stored in the non-volatile memory may be replaced by the changed data when the system is rebooted so it can then be used by the operating system.

Next, the ACPI table is reinstalled in the main memory using the changed ACPI table 180 (S350). Here, the reinstalled ACPI table 180 is not the ACPI table 180 loaded to the main memory in step S320 but is the ACPI table 180 changed in step S340. In addition, the memory device to which the ACPI table 180 is loaded may be separately provided.

In an exemplary embodiment, the ACPI table is initially loaded from a ROM or a writable non-volatile memory, then stored in a location of the main memory that is being used by the system for purposes such as hardware discovery, configuration, power management, monitoring, etc, the changed ACPI table is stored in the writable non-volatile memory and another second location of the main memory that is not being used for these purposes, and the reinstalling of the ACPI table means that the system will now refer to the changed ACPI table in the main memory (e.g., by referring to the second location, by overwriting the data stored in the first location with the changed ACPI table, etc.).

FIG. 5 is a block diagram of a computer system to which the method for controlling ACPI information shown in FIG. 4 may be applied.

Referring to FIG. 5, the computer system 400 may include a non-volatile memory 430, a UEFI 420 and a shell application 410.

The non-volatile memory 430 may include the ACPI table 180 shown in FIG. 1. In an exemplary embodiment, the non-volatile memory 430 is a flash memory, but exemplary embodiments of the present inventive concept are not limited thereto. The UEFI 420 may be configured in substantially the same manner as the UEFI 190 shown in FIG. 1.

The shell application 410 may be provided by the UEFI boot service. In an exemplary embodiment of the present inventive concept, the ACPI table is directly accessed through the shell application 410. The user may modify, add or remove information from the ACPI table using the shell application 410. The user may also retrieve (read/return) information about or within the ACPI table using the shell application 410.

To this end, an extended command for directly accessing the ACPI table and controlling the information about or within the ACPI table may be added to the shell application 410. The shell application 410 may provide a facility to enable the user to add the extended command. The shell application 410 may interface with the ACPI table protocol through the extended command. The shell application 410 may include a command parser for calling the ACPI table protocol corresponding to the extended command.

In order to add the extended command to the shell application 410, a function for processing the extended command, when the extended command is input, may further be added to functions of driving the shell application 410. In an exemplary embodiment, the UEFI 420 uses an EFI boot loader (EBL) command. The EBL command may include various commands, such as Reset, exit, help, break, page, pause, sleep, hexdump, and so on. If the EBL command is input through the shell application 410, a function for parsing the input EBL command and processing the same may be called. In an exemplary embodiment of the present inventive concept, a function for adding the extended command in an EBL command format and processing the extended command is added.

FIG. 6 illustrates a table for explaining extended commands shown in FIG. 5 according to exemplary embodiments of the inventive concept.

Referring to FIG. 6, the extended command may include an ACPI Modify command, an ACPI Create command, and an ACPI Remove command. The ACPI Modify command may be configured to modify and update the ACPI table. The ACPI Create command may be configured to add or create an initial ACPI table or to create a new ACPI file. The ACPI Remove command may be configured to uninstall the ACPI table.

The extended command may also include an ACPI Get command. The ACPI Get command may be configured to return information about or within the ACPI table. The ACPI Get command may be a command for returning the ACPI table information loaded to the main memory. In an exemplary embodiment, if the ACPI Get command is executed, the ACPI table information corresponding to a filepath input as a factor (e.g., an input parameter) is displayed on the terminal window, and the user confirms the displayed ACPI table information to input an ACPI Modify command, an ACPI Create command or an ACPI Remove command.

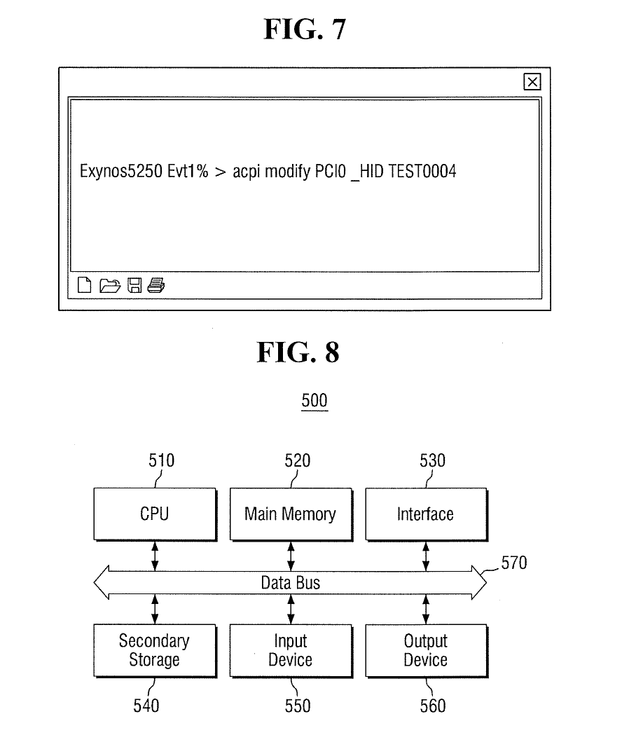

FIG. 7 illustrates that an extended command is input to a terminal window according to an exemplary embodiment of the inventive concept.

Referring to FIG. 7, the terminal window on which the shell application 410 is executed is illustrated. As shown in FIG. 7, the user may input the ACPI Modify command, for example, to the terminal window. When the ACPI Modify command is executed, a function for modifying a device ID data object value of a PCI bus package object to TEST0004, may be called.

Referring again to FIG. 5, the UEFI 420 may provide the ACPI table protocol. The ACPI table protocol may be used to install the ACPI table in the main memory or uninstall the installed ACPI table from the main memory. Parameters of the ACPI table protocol may include InstallAcpiTable and UninstalAcpiTable. The InstallAcpiTable( ) function enables the caller to install the ACPI table. When the InstallAcpiTable( ) function is normally executed, an intrinsic table key for referring to the ACPI table is returned. The UninstallAcpiTable( ) function enables the caller to uninstall the ACPI table. In order to uninstall the ACPI table, the table key may be used.

In an exemplary embodiment of the present inventive concept, when the ACPI Modify command, the ACPI Create command or the ACPI Remove command is executed, the InstallAcpiTable( )function is called. The InstallAcpiTable( ) function may be a function for calling a SetAcpiTable( ) function. The SetAcpiTable( ) function may be a function for updating, adding (e.g., creating) or uninstalling the ACPI table. The SetAcpiTable( ) function may be set by changing the content of the ACPI table based on data input as a factor (e.g., a parameter).

A routine for storing the content of the changed ACPI table in the non-volatile memory may be added to the ACPI table protocol. The changed ACPI table may be stored in the non-volatile memory in a file format.

The above-described method for controlling the ACPI information may be applied to various computer systems including a desk top computer, a workstation, a server, a mobile system, a tablet computer, a smartphone, and so on.

FIG. 8 is a block diagram for explaining an application example of a computer system to which the method for controlling ACPI information shown in FIG. 4 may be applied.

Referring to FIG. 8, the computer system 500 includes a central processing unit (CPU) 510, a main memory 520, an interface 530, a secondary memory 540, an input device 550, an output device 560, and a data bus 570.

The CPU 510, the main memory 520, the interface 530, the secondary memory 540, the input device 550 and the output device 560 may be connected to each other through the data bus 570. The data bus 570 may be an electrical path through which data is exchanged among the CPU 510, the main memory 520, the interface 530, the secondary memory 540, the input device 550 and the output device 560.

The CPU 510, including a controlling device, an operating device, and so on, may execute a program and may process data. The CPU 510 may execute the UEFI 420 and the shell application 410 described above with reference to FIG. 5.

The main memory 520 may receive/transmit data from/to the CPU 510 and may store data and/or commands required to execute the program.

The interface 530 may transmit data to a communication network or may receive data from the communication network (e.g., the internet, a local area network, etc.).

The secondary memory 540 may include a non-volatile memory, such as a floppy disk, a hard disk, CD-ROM, or DVD and may store data and/or commands. The secondary memory 540 may also include a flash memory. The flash memory may store the ACPI table in a file format.

The input device 550 may input data using a mouse, a keyboard, etc.

The output device 560 may output data using a monitor, a speaker, etc.

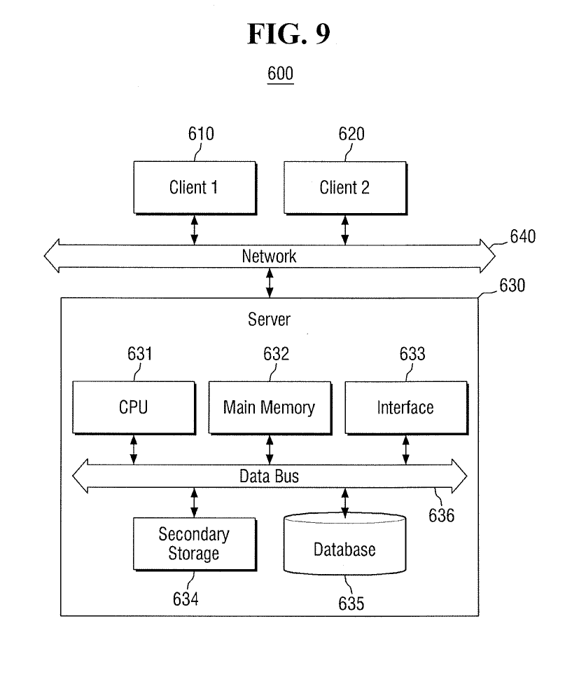

FIG. 9 is a block diagram for explaining another application example of a computer system to which the method for controlling ACPI information shown in FIG. 4 may be applied.

Referring to FIG. 9, the computer system 600 includes a first client (Client 1) 610, a second client (Client 2) 620, and a server 630. The first client 610 and the second client 620 may be connected to the server 630 through a network 640 (e.g., the internet, a local area network, etc.). The network may be wired or wireless.

The first client 610 and the second client 620 may be configured in substantially the same manner as those of the computer system 500 shown in FIG. 8.

The server 630 includes a CPU 631, a main memory 632, an interface 633, a secondary memory 634, a database 635, and a data bus 636.

The CPU 631, the main memory 632, the interface 633, the secondary memory 634 and the data bus 636 may be configured in substantially the same manner as the CPU 510, the main memory 520, the interface 530, the secondary memory 540 and the data bus 570 described above with reference to FIG. 8.

The CPU 631 may execute the UEFI 420 and the shell application 410 described above with reference to FIG. 5. The secondary memory 634 may include a flash memory. The flash memory may store the ACPI table in a file format.

The database 635 may manage a data set having a predetermined structure to store or provide data in response to the request from clients 610 and 620.

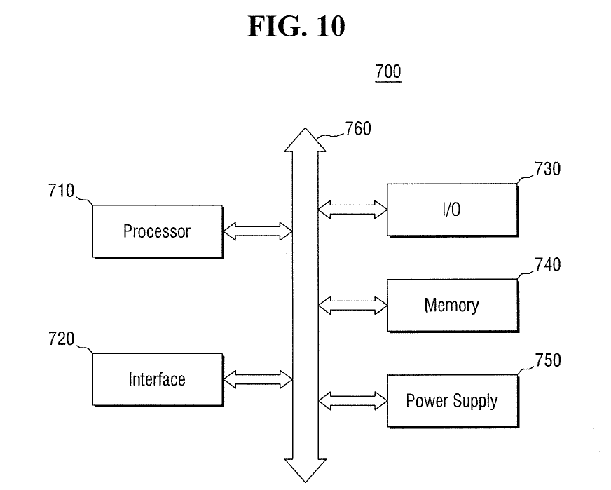

FIG. 10 is a block diagram for explaining an application example of a computer system to which the method for controlling ACPI information shown in FIG. 4 may be applied.

Referring to FIG. 10, the computer system 700 includes a processor 710, an interface 720, an input/output device (I/O) 730, a memory 740, a power supply 750, and a bus 760.

The processor 710, the interface 720, the I/O 730, the memory 740, and the power supply 750 may be connected to each other through the bus 760. The bus 760 corresponds to an electrical path used to exchange data among processor 710, interface 720, I/O 730, memory 740, and power supply 750.

The processor 710 may include at least one of a microprocessor, a microcontroller, and logic elements capable of performing similar functions and may process data. The processor 710 may execute the UEFI 420 and the shell application 410 described above with reference to FIG. 5.

The interface 720 may be used to transmit data to a wireless data network or receive data from the communication network. As an example, the interface 720 may include an antenna or a wireless transceiver.

The I/O 730 may include a keypad, a keyboard, a display, and so on, and may input/output data.

The memory 740 may store data and/or commands. The memory 740 may include a flash memory. The flash memory may store the ACPI table in a file format.

The power supply 750 may convert externally applied power and may supply the converted power to each of the components 710 to 740.

At least one embodiment of the inventive concept can be embodied as computer readable codes having computer executable instructions on a computer-readable medium. For example, the operations of FIG. 4 may be embodied as computer executable instructions. The computer-readable recording medium is any data storage device that can store data as a program which can be thereafter read by a computer system. Examples of the computer-readable recording medium include read-only memory (ROM), random-access memory (RAM), CD-ROMS, magnetic tapes, floppy disks, and optical storage devices.

Although exemplary embodiments of the present inventive concept have been described for illustrative purposes, various modifications, additions and substitutions are can be made to these exemplary embodiments without substantially departing from the principles, scope, or spirit of the present inventive concept.

What is claimed is:

1. A computer system for controlling advanced configuration and power interface (ACPI) information, the computer system comprising:
a non-volatile memory configured to store an ACPI table; and
a processor configured to execute a unified extensible firmware interface (UEFI),
wherein a boot service of the UEFI provides a shell application, and the shell application includes an extended command to control information of the ACPI table.

2. The computer system of claim 1, wherein the shell application further includes a command parser configured to call an ACPI table protocol corresponding to the extended command.

3. The computer system of claim 1, wherein the extended command includes at least one of an ACPI Modify command configured to modify the information of the ACPI table, an ACPI Add command configured to create the ACPI table, and an ACPI Remove command configured to remove the ACPI table.

4. The computer system of claim 3, wherein the ACPI Modify command, the ACPI Add command and the ACPI Remove command are commands configured to load the ACPI table from the non-volatile memory to a main memory and change the ACPI table loaded to the main memory.

5. The computer system of claim 4, wherein the ACPI Modify command, the ACPI Add command and the ACPI Remove command are commands configured to store in the non-volatile memory the ACPI table loaded to the main memory and changed.

6. The computer system of claim 4, wherein the ACPI Modify command, the ACPI Add command and the ACPI Remove command are commands configured to reinstall the ACPI table in the main memory using the ACPI table loaded to the main memory and changed.

7. The computer system of claim 1, wherein the extended command includes an ACPI Get command configured to return the information of the ACPI table.

8. The computer system of claim 7, wherein the ACPI Get command is a command configured to load the ACPI table from the non-volatile memory to the main memory and return the information of the ACPI table loaded to the main memory.

9. A method for controlling advanced configuration and power interface ACPI information, the method comprising:
loading a shell application provided from a unified extensible firmware interface UEFI boot service;
receiving an extended command for controlling information of an ACPI table using the shell application;
changing the ACPI table according to the received extended command; and
storing the changed ACPI table in a non-volatile memory.

10. The method of claim 9, wherein the receiving of the extended command comprises receiving at least one of an ACPI Modify command for modifying the information of the ACPI table, an ACPI Add command for creating the ACPI table, and an ACPI Remove command for removing the ACPI table.

11. The method of claim 10, wherein the ACPI Modify command, the ACPI Add command and the ACPI Remove command are commands configured to load the ACPI table from the non-volatile memory to a main memory and change the ACPI table loaded to the main memory.

12. The method of claim 11, wherein the storing of the changed ACPI table in the non-volatile memory comprises storing in the non-volatile memory the ACPI table loaded to the main memory and changed.

13. The method of claim 11, further comprising reinstalling the ACPI table in the main memory using the ACPI table loaded to the main memory and changed.

14. The method of claim 9, wherein the receiving of the extended command comprises receiving an ACPI Get command for returning the information of the ACPI table.

15. The method of claim 14, wherein the ACPI Get command is a command configured to load the ACPI table from the non-volatile memory to the main memory and return the information of the ACPI table loaded to the main memory.

16. A computer system configured to control advanced configuration and power interface (ACPI) information, the computer system comprising:
a main memory configured to store an ACPI table;
a processor configured to execute a unified extensible firmware interface (UEFI),
wherein a boot service of the UEFI provides a shell application, and the shell application includes an extended command configured to change the ACPI table.

17. The computer system of claim 16, further comprising a read-write non-volatile memory, and the extended command stores the changed ACPI table in the non-volatile memory.

18. The computer system of claim 17, wherein the extended command reinstalls the ACPI table in the main memory using the changed ACPI table.

19. The computer system of claim 16, wherein the shell application further includes a command parser configured to call an ACPI table protocol corresponding to the extended command.

20. The computer system of claim 16, wherein the processor is a 64 bit processor.
